(19) United States
(12) Patent Application Publication
(10) Pub. No.: US 2010/0105271 A1
(43) Pub. Date: Apr. 29, 2010

(54) PH Buffering Hybrid Material and the Forming Method Thereof

(75) Inventors: Wen-Chang Chen, Taipei City (TW); Wen-Yen Chiu, Taipei City (TW); Kuo-Chuan Ho, Taipei City (TW); Chi-An Dai, Taipei City (TW); Jui-Hung Chen, Taipei City (TW)

Correspondence Address: WPAT, PC;INTELLECTUAL PROPERTY ATTORNEYS, 7225 BEVERLY ST., ANNANDALE, VA, 22003, US

(73) Assignee: NATIONAL TAIWAN UNIVERSITY, Taipei City (TW)

(21) Appl. No.: 12/258,574

(22) Filed: Oct. 27, 2008

(51) Int. Cl. B32B 9/04; B05D 3/02; B05D 3/12; B32B 5/16; B32B 17/06

(52) U.S. Cl. 442/327; 427/385.5; 427/240; 428/426; 428/221; 428/702; 428/328

(57) ABSTRACT

The present invention discloses a pH buffering hybrid material and the forming method thereof. The pH buffering hybrid material comprises a substrate, a conductive polymer layer on the substrate, and a ZnO nanorod layer produced by deposition of ZnO particles as nucleuses on the conductive polymer layer, and the ZnO particles growing into the ZnO nanorods via hydrothermal reaction. The pH buffering hybrid material has the pH turning ability and the potential of conductivity.

### BACKGROUND OF THE INVENTION

1. Field of the Invention

The present invention is generally related to pH buffering hybrid materials and more particularly to pH buffering hybrid materials with ZnO nanorods/conductive layer structure.

2. Description of the Prior Art

Zinc oxide is a versatile material and has been used considerably frequently for its catalytic, electrical, and photochemical. In recent years, zinc oxide has attracted notice due to its potential applications in optoelectronic devices, such as short-wavelength lasers and light-emitting diodes. Moreover, the pH buffering range of current pH buffering material is either for acid or for bases, but not both. Zinc oxide is an amphoteric oxide, and the property of zinc oxide acts as acid or base depending on the reaction in which it is involved. The method of forming a pH buffering material with a wide buffering range has become an important technique for the current market trend.

U.S. Pat. No. 7,351,607 [Wang Zhong L., Summers Christopher J., Wang Xudong, Graugnard Elton D., King Jeffrey, “Large scale patterned growth of aligned one-dimensional nanostructures”, 2008.] discloses a method of making nanostructures using a self-assembled monolayer of organic spheres. The nanostructures include bowl-shaped structures and patterned elongated nanostructures. A bowl-shaped nanostructure with a nanorod grown from a conductive substrate through the bowl-shaped nanostructure may be configured as a field emitter or a vertical field effect transistor.

U.S. Pat. No. 7,202,173 [Hantschel; Thomas, Johnson; Noble M., Kiesel; Peter, Van De Walle; Christian G., Wong; William S. “Systems and methods for electrical contacts to arrays of vertically aligned nanorods”, 2007.] discloses systems and methods providing electrical contacts to an array of substantially vertically aligned nanorods. The nanorod array may be fabricated on top of a conducting layer that serves as a bottom contact to the nanorods. A top metal contact may be applied to a plurality of nanorods of the nanorod array. The contacts may allow I/V (current/voltage) characteristics of the nanorods to be measured.

For most reports on ZnO nanorods growth, the vapor-liquid-solid (VLS) process has been used, which results in high costs of production. How to fabricate the buffering material with simple structure, fast respond, and low cost has become the current trend in buffering material development of the material industry and the textile industry.

### SUMMARY OF THE INVENTION

In accordance with the present invention, the method of forming a pH buffering hybrid material is provided for commercial need and with advantages of low cost and minor pollution.

The present invention further discloses the pH buffering hybrid material. The buffering range of the pH buffering hybrid material is from acid to base, so that provided the pH buffering hybrid material is a potential candidate for the next generation of buffering material.

The present invention discloses the pH buffering hybrid material, comprising: a substrate, a conductive polymer layer on the substrate, and a ZnO nanorod layer produced by deposition of ZnO particles as nucleuses on the conductive polymer layer and the ZnO particles growing into the ZnO nanorods via hydrothermal reaction.

### BRIEF DESCRIPTION OF THE DRAWINGS

FIG. 1 is a transmission electron microscopy (TEM) image of the Zinc oxide nanoparticles according to the example of the present invention;

FIG. 2 is a scanning electron microscopy (SEM) image of the PEDOT thin film according to the example of the present invention;

FIG. 3 is a SEM image of the PEDOT thin film (without the imidazole) according to the example of the present invention;

FIG. 4 is a X-ray diffraction (XRD) pattern of zinc oxide nanoparticles on the PEDOT thin film according to the example of the first embodiment of the present invention;

FIGS. 5A and 5B are SEM images of zinc oxide nanorods on ZnO particle/conductive layer according to the example of the present invention; and

FIG. 6 is a pH response diagram versus time with different initial pH value according to the example of the present invention.

### DESCRIPTION OF THE PREFERRED EMBODIMENTS

What is probed into the invention is a pH buffering hybrid material. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following specification. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

A first embodiment of the present invention discloses a method of forming a pH buffering hybrid material, comprising: providing a substrate; forming a conductive polymer layer on the substrate to form a first substrate; performing a deposition process using a ZnO solution to contact the first substrate to deposit ZnO particles on the conductive polymer layer of the first substrate, so as to form a second substrate; soaking the second substrate in the zinc ion solution; and performing a hydrothermal reaction of the second substrate and the zinc ion solution to form ZnO nanorods growing from the ZnO particles, whereupon the pH buffering hybrid material with ZnO nanorods/conductive layer is formed. In addition, the above-mentioned hydrothermal reaction uses the ZnO particles as nucleuses and allowing the ZnO particles to grow in a fixed direction to form the ZnO nanorods, and the temperature of the hydrothermal reaction ranges from 60° C. to 95° C. The diameter of the above-mentioned ZnO particles ranges from 4 nm to 6 nm.

The above-mentioned substrate comprises one selected from the group consisting of the following: glass, fiber cloth, non-woven fiber, plastic film, ceramic substrate. Moreover, the conductive monomer comprises one selected from the group consisting of the following: 3,4-ethylenedioxythiophene (EDOT), thiophene, aniline, and their derivatives. The zinc ion solution comprises one selected from the group consisting of the following: zinc nitrate, zinc acetate, and zinc phosphate, and the zinc ion solution further comprises an alkaline reagent selected from the group consisting of the following: hexamethylenetetramine (HMTA), NaOH, and NH₄OH.

The method of forming the conductive polymer layer comprises: performing a first coating process to coat a mixed solution on the substrate, wherein the mixed solution comprises a conductive monomer, an initiator, and a solvent; and performing a first heating process to polymerize the conductive polymer to form the conductive polymer layer, so as to form the first substrate. The above-mentioned first coating process comprises one selected from the group consisting of the following: spin coating, blade coating, and dipping coating method. The above-mentioned solvent comprises one selected from the group consisting of the following: butanol, methanol, ethanol, water, tetrahydrofuran, N,N-dimethylformamide, dimethyl sulfoxide, N-methyl-2-pyrrolidone, Propylene Glycol Methyl Ether Acetate, and toluene. The above-mentioned initiator comprises one selected from the group consisting of the following: Fe(OTs)₃, FeCl₃, and APS. The temperature of the first heating process ranges from 75° C. to 130° C.

Moreover, the deposition process further comprises: performing a second coating process to coat a ZnO particle solution on the first substrate; and performing a second heating process to form a second substrate with ZnO particle/conductive layer. The above-mentioned second coating process comprises one selected from the group consisting of the following: spin coating, and dipping coating method. The temperature of the above-mentioned second heating process ranges from 140° C. to 200° C.

Besides, an annealing process is performed after forming the second substrate with ZnO particle/conductive layer. The temperature of the above-mentioned annealing process is from 140° C. to 200° C. The pH tuning range of the pH buffering hybrid material is from pH=4 to pH=10.

A second embodiment of the present invention discloses a pH buffering hybrid material, comprising: a substrate; a conductive polymer layer on the substrate; and a ZnO nanorod layer produced by deposition of ZnO particles as nucleuses on the conductive polymer layer, and the ZnO particles growing into the ZnO nanorods via hydrothermal reaction. The temperature of the hydrothermal reaction ranges from 60° C. to 95° C. The above-mentioned hydrothermal reaction uses the ZnO particles as nucleuses and allowing the ZnO particles to grow in a fixed direction to form the ZnO nanorods. The diameter of the above-mentioned ZnO particles ranges from 4 nm to 6 nm. The above-mentioned zinc ion solution comprises one selected from the group consisting of the following: zinc nitrate, zinc acetate, and zinc phosphate, and the zinc ion solution further comprises an alkaline reagent selected from the group consisting of the following: hexamethylenetetramine (HMTA), NaOH, and NH₄OH.

In addition, the substrate comprises one selected from the group consisting of the following: glass, fiber cloth, non-woven fiber, plastic film, ceramic substrate. The conductive polymer layer is polymerized by conductive monomer, where the conductive monomer comprises one selected from the group consisting of the following: 3,4-ethylenedioxythiophene (EDOT), thiophene, aniline, and their derivatives.

The above-mentioned method of forming the conductive polymer layer comprises: performing a first coating process to coat a mixed solution on the substrate, wherein the mixed solution comprises a conductive monomer, an initiator, and a solvent; and performing a first heating process to polymerize the conductive polymer to form the conductive polymer layer. The first coating process comprises one selected from the group consisting of the following: spin coating, blade coating, and dipping coating method. The above-mentioned solvent comprises one selected from the group consisting of the following: butanol, methanol, ethanol, water, tetrahydrofuran, N,N-dimethylformamide, dimethyl sulfoxide, N-methyl-2-pyrrolidone, Propylene Glycol Methyl Ether Acetate, and toluene. The above-mentioned initiator comprises one selected from the group consisting of the following: Fe(OTs)₃, FeCl₃, and APS. On the other hand, the mixed solution further comprises an aromatic amine comprises one selected from the group consisting of the following: imidazole and imidazole derivative. The temperature of the first heating process ranges from 75° C. to 130° C.

Moreover, the above-mentioned deposition of a ZnO particle on the conductive polymer layer is prepared by performing a second coating process to coat a ZnO particle solution on the conductive polymer layer of substrate and performing a second heating process. The second coating process comprises one selected from the group consisting of the following: spin coating, and dipping coating method. The temperature of the above-mentioned second heating process ranges from 140° C. to 200° C.

The pH buffering range of the pH buffering hybrid material is from pH 4 to pH 10.

### EXAMPLE

### Forming the Zinc Oxide Nnanoparticle Solution

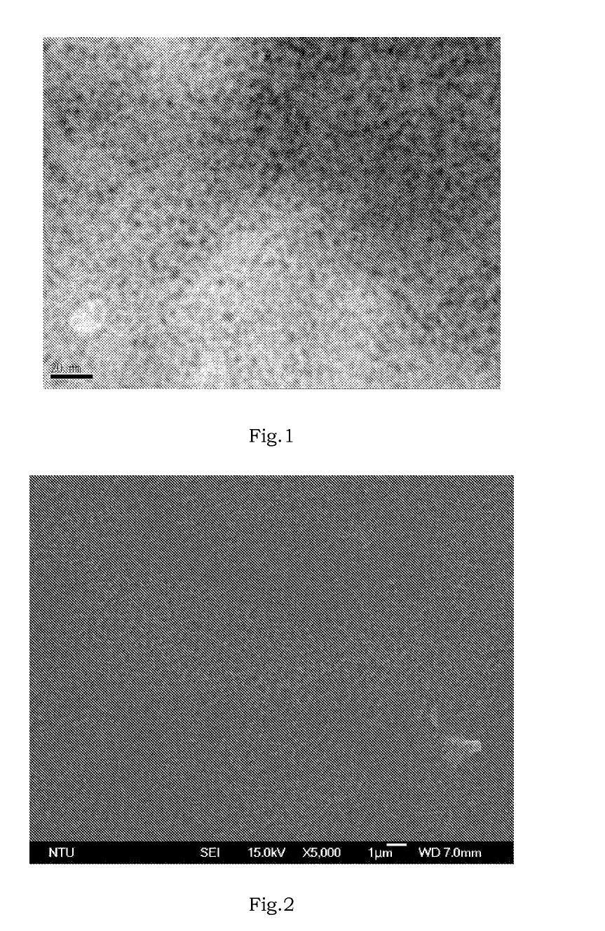

Zn(CH₃COO)₂ (0.219 g) is dissolved in methanol (30 g), and then NaOH (0.08 g) is dissolve in methanol (10 g). The NaOH/Methanol solution is dropped into the Zn(CH₃COO)₂/Methanol solution. After having been refluxed for 2 hours, the product is the zinc oxide nanoparticle solution. FIG. 1 is the TEM image of zinc oxide nanoparticle, and the diameter of the zinc oxide nanoparticle is from 5 nm to 6 nm. A general zinc oxide nanoparticle reaction equation is as follows:

Zn(CH₃COO)₂+2NaOH═ZnO+2NaCH₃COO+H₂O

### The Process of Polymerization of PEDOT Thin Film

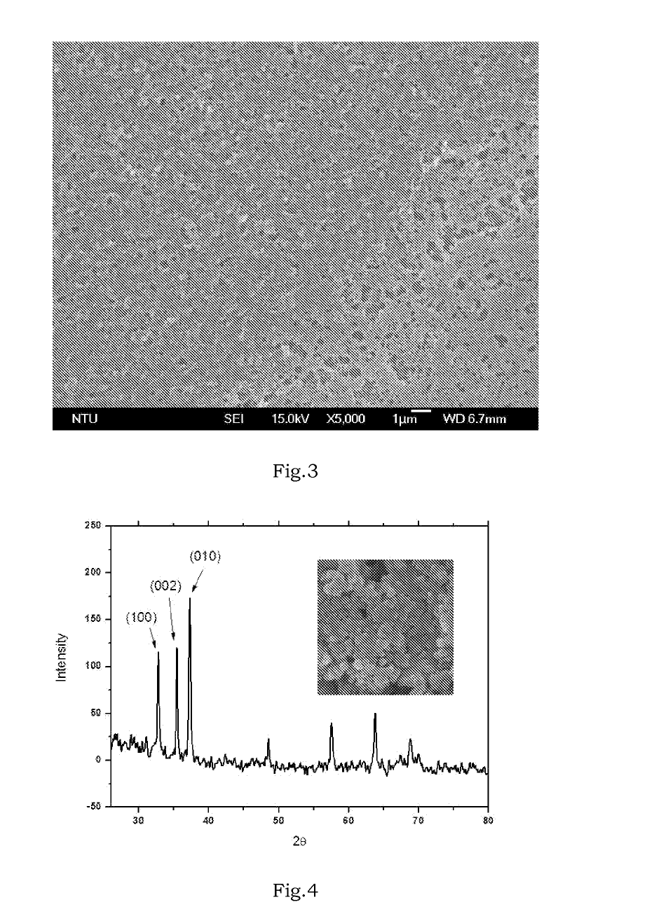

EDOT (0.08 g) and imidazole (0.05 g) are dissolved in butanol (1 g) and then Fe(OTs)₃ (0.89 g) is dissolved in butanol (1 g). Mix these two solutions. Then, spin coating it on the glass at 1000 RPM for 10 seconds and put the product into oven at 110° C. for ten minutes to form a PEDOT thin film. FIG. 2 is the SEM image of the above-mentioned PEDOT thin film. If precursors do not include the imidazole, the surface of the PEDOT thin film is more rough than that of the precursor with imidazole added (FIG. 3).

### The Process of Spin Coating Zinc Oxide Nanoparticles on the PEDOT Thin Film

Zinc oxide nanoparticles are deposited on the PEDOT thin film at 1000 rpm for 10 seconds, and then put the product into the oven at 140° C. for 10 minute. Repeat it for 3 times to form a substrate with ZnO particle/conductive layer.

As shown in FIG. 4, the XRD pattern of zinc oxide nanoparticles on the PEDOT thin film shows that the zinc oxide nanoparticles have (100), (002), (010) diffraction peaks. Zinc oxide particles are used as nucleuses and allowing Zinc oxide particles to grow in a fixed direction to form ZnO nanorods.

### The Process of Forming Zinc Oxide Nanorods on ZnO Particle/Conductive Layer

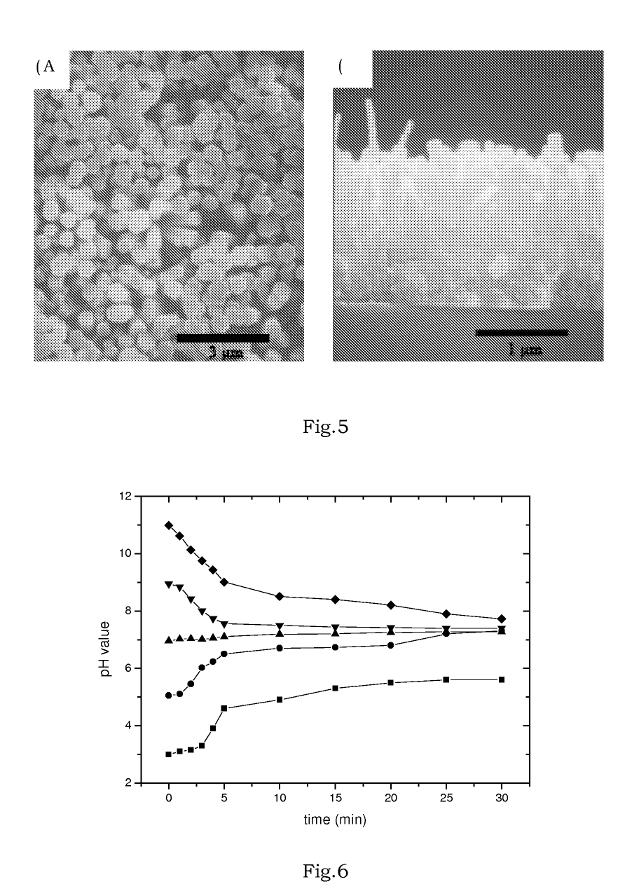

Zinc (0.092 g) acetate and hexamethylenetetramine (0.14 g) are dissolved in H₂O (10 g). Soak the substrate with ZnO particle/conductive layer in it. After putting it into the oven at 95° C. for 6 hours, take it out of the solution and wash it with D.I. water. As shown in FIGS. 5A and 5B, the length of ZnO nanorod is from 2 micrometer to 3 micrometer.

### The pH Buffering Ability of ZnO Nanorod/Conductive Layer

ZnO nanorod/conductive layer is soaked into the aqua solution at pH 3, 5, 7, 9, 11. The weight of the aqua solution is 1000 times of ZnO nanorod/conductive layer. Record the pH value in 30 minutes. As shown in FIG. 6, the pH value is turned to 7.5-8 by the pH buffering material in 30 minutes.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A method of forming a pH buffering hybrid material, comprising:
providing a substrate;
forming a conductive polymer layer on said substrate to form a first substrate;
performing a deposition process using a ZnO solution to contact said first substrate to deposit ZnO particles on said conductive polymer layer of said first substrate, so as to form a second substrate with ZnO particle/conductive layer;
soaking said second substrate in said zinc ion solution; and
performing a hydrothermal reaction of said second substrate and said zinc ion solution to form ZnO nanorods growing from the ZnO particles, whereupon said pH buffering hybrid material with ZnO nanorods/conductive layer is formed.

2. The method of forming a pH buffering hybrid material according to claim 1, wherein said hydrothermal reaction uses said ZnO particles as nucleuses and allowing ZnO particles to grow in a fixed direction to form the ZnO nanorods.

3. The method of forming a pH buffering hybrid material according to claim 1, wherein said substrate comprises one selected from the group consisting of the following: glass, fiber cloth, non-woven fiber, plastic film, ceramic substrate.

4. The method of forming a pH buffering hybrid material according to claim 1, wherein said conductive polymer layer is polymerized by conductive monomer, where said conductive monomer comprises one selected from the group consisting of the following: 3,4-ethylenedioxythiophene (EDOT), thiophene, aniline, and their derivatives.

5. The method of forming a pH buffering hybrid material according to claim 1, wherein the method of forming said conductive polymer layer comprises:
performing a first coating process to coat a mixed solution on said substrate, wherein said mixed solution comprises a conductive monomer, an initiator, and a solvent; and
performing a first heating process to polymerize said conductive polymer to form said conductive polymer layer, so as to form said first substrate.

6. The method of forming a pH buffering hybrid material according to claim 5, wherein said first coating process comprises one selected from the group consisting of the following: spin coating, blade coating, and dipping coating method.

7. The method of forming a pH buffering hybrid material according to claim 5, wherein said solvent comprises one selected from the group consisting of the following: butanol, methanol, ethanol, water, tetrahydrofuran, N,N-dimethylformamide, dimethyl sulfoxide, N-methyl-2-pyrrolidone, Propylene Glycol Methyl Ether Acetate, and toluene.

8. The method of forming a pH buffering hybrid material according to claim 5, wherein said initiator comprises one selected from the group consisting of the following: Fe(OTs)₃, FeCl₃, and APS.

9. The method of forming a pH buffering hybrid material according to claim 5, wherein said mixed solution further comprises an aromatic amine selected from the group consisting of the following: imidazole and imidazole derivative.

10. The method of forming a pH buffering hybrid material according to claim 5, wherein the temperature of said first heating process ranges from 75° C. to 130° C.

11. The method of forming a pH buffering hybrid material according to claim 1, wherein said deposition process comprises:
performing a second coating process to coat a ZnO particle solution on said first substrate; and
performing a second heating process to form a second substrate with ZnO particle/conductive layer.

12. The method of forming a pH buffering hybrid material according to claim 11, wherein said second coating process comprises one selected from the group consisting of the following: spin coating, and dipping coating method.

13. The method of forming a pH buffering hybrid material according to claim 11, wherein the temperature of said second heating process ranges from 140° C. to 200° C.

14. The method of forming a pH buffering hybrid material according to claim 1, wherein the diameter of said ZnO particles ranges from 4 nm to 6 nm.

15. The method of forming a pH buffering hybrid material according to claim 1, wherein said zinc ion solution comprises one selected from the group consisting of the following: zinc nitrate, zinc acetate, and zinc phosphate.

16. The method of forming a pH buffering hybrid material according to claim 1, wherein said zinc ion solution further comprises an alkaline reagent selected from the group consisting of the following: hexamethylenetetramine (HMTA), NaOH, and NH₄OH.

17. The method of forming a pH buffering hybrid material according to claim 1, wherein the temperature of said hydrothermal reaction ranges from 60° C. to 95° C.

18. The method of forming a pH buffering hybrid material according to claim 1, wherein an annealing process is performed after forming said second substrate with ZnO particle/conductive layer.

19. The method of forming a pH buffering hybrid material according to claim 18, wherein the temperature of said annealing process ranges from 140° C. to 200° C.

20. The method of forming a pH buffering hybrid material according to claim 1, wherein the pH tuning range of said pH buffering hybrid material is from pH 4 to pH 10.

21. A pH buffering hybrid material, comprising:
a substrate;
a conductive polymer layer on said substrate; and
a ZnO nanorod layer produced by deposition of ZnO particles as nucleues on said conductive polymer layer, and the ZnO particles growing into the nanorods via hydrothermal reaction.

22. The pH buffering hybrid material according to claim 21, wherein said substrate comprises one selected from the group consisting of the following: glass, fiber cloth, non-woven fiber, plastic film, ceramic substrate.

23. The pH buffering hybrid material according to claim 21, wherein said conductive polymer layer is polymerized by conductive monomer, where said conductive monomer comprises one selected from the group consisting of the following: 3,4-ethylenedioxythiophene (EDOT), thiophene, aniline, and their derivatives.

24. The pH buffering hybrid material according to claim 21, wherein the diameter of said ZnO particles ranges from 4 nm to 6 nm.

25. The pH buffering hybrid material according to claim 21, wherein the pH buffering range of said pH buffering hybrid material is from pH 4 to pH 10.
